(19) United States
(12) Patent Application Publication
(10) Pub. No.: US 2023/0297040 A1
(43) Pub. Date: Sep. 21, 2023

(54) FIELD INSTALLATION CONTROL SYSTEM AND METHOD BASED ON HYBRID DIGITAL TWIN MODEL FOR PROCESS OPERATION OPTIMIZATION

(71) Applicant: SDPlex Co Ltd., Seoul (KR)

(72) Inventors: Joo Hwan NOH, Seoul (KR); Sang Jin YUN, Anyang-si (KR)

(21) Appl. No.: 18/183,841

(22) Filed: Mar. 14, 2023

(30) Foreign Application Priority Data
Mar. 15, 2022 (KR) 10-2022-0031989
May 4, 2022 (KR) 10-2022-0055551

(51) Int. Cl. G05B 13/04; G05B 13/02

(52) U.S. Cl. CPC G05B 13/04; G05B 13/027

(57) ABSTRACT

Proposed are a field installation control system and method for process operation optimization. The field installation control system includes a data collection subsystem configured to collect installation operation data, from one or more field installations, a data analysis subsystem configured to analyze the data collected by the data collection subsystem, a control subsystem configured to control the one or more field installations, based on an output of the data analysis subsystem, and a network for communicatively connecting the subsystems to each other. The data analysis subsystem includes a hybrid digital twin model configured to process the data processed by the data processing module, wherein the hybrid digital twin model is a fusion of an artificial intelligence learning and inference model with a physical model regarding the one or more field installations, and is trained based on installation operation data regarding the one or more field installations.

### CROSS-REFERENCE TO RELATED APPLICATION

This application is based on and claims priority under 35 U.S.C. § 119 to Korean Patent Application No. 10-2022-0055551, filed on May 4, 2022, and Korean Patent Application No. 10-2022-0031989, filed on Mar. 15, 2022, in the Korean Intellectual Property Office, the disclosure of each of which is incorporated by reference herein in its entirety.

### BACKGROUND

### Technical Field

The present disclosure relates to a field installation control system and method based on a hybrid digital twin model for process operation optimization.

### Description of Related Technology

A digital twin is a digital replica of a physical object (e.g., an installation, an asset, a process, a system, etc.), and refers to a virtual model that maintains the properties/states of target object elements and describes dynamic nature regarding how they behave. Digital twin technology is attracting attention as demands for improvement in productivity, economic feasibility, and stability in industrial sites is spreading.

### SUMMARY

Provided are a field installation control system and method based on a hybrid digital twin model for process operation optimization. Technical objects of the present disclosure are not limited to the foregoing, and other unmentioned objects or advantages of the present disclosure would be understood from the following description and be more clearly understood from the embodiments of the present disclosure. In addition, it would be appreciated that the objects and advantages of the present disclosure can be implemented by means provided in the claims and a combination thereof.

Additional aspects will be set forth in part in the description which follows and, in part, will be apparent from the description, or may be learned by practice of the presented embodiments of the disclosure.

According to a first aspect of the present disclosure, a field installation control system includes a data collection subsystem configured to collect installation operation data, from one or more field installations, a data analysis subsystem configured to analyze the data collected by the data collection subsystem, a control subsystem configured to control the one or more field installations, based on an output of the data analysis subsystem, and a network for communicatively connecting the subsystems to each other, wherein the data analysis subsystem includes a data processing module configured to process the data collected by the data collection subsystem, a hybrid digital twin model configured to process the data processed by the data processing module, and a signal generation module configured to analyze the data processed by the hybrid digital twin model and output a control information signal, and the hybrid digital twin model is a fusion of an artificial intelligence learning and inference model, which is based on installation operation data, with a physical model regarding the one or more field installations, and is trained based on installation operation data regarding the one or more field installations.

According to a second aspect of the present disclosure, a field installation control method for process operation optimization includes collecting installation operation data from one or more field installations, analyzing the collected data, and controlling the one or more field installations, based on a result of the analyzing, wherein the analyzing of the collected data includes processing the collected data, processing the processed data, through a hybrid digital twin model, and generating a control information signal by analyzing the data processed by the hybrid digital twin model, and the hybrid digital twin model is a fusion of an artificial intelligence learning and inference model, which is based on installation operation data, with a physical model regarding the one or more field installations, and is trained based on installation operation data regarding the one or more field installations.

According to a third aspect of the present disclosure, a computer-readable recording medium may have recorded thereon a program for executing, on a computer, the method according to the second aspect.

In addition, other methods and apparatuses for implementing the present disclosure, and a computer-readable recording medium having recorded thereon a program for executing the method may be further provided.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a diagram for describing an example of edge computing.

FIG. 2 is a block diagram of a field installation control system for process operation optimization according to an embodiment.

FIG. 3 is a block diagram illustrating a data analysis subsystem according to an embodiment.

FIGS. 4A and 4B are schematic diagrams for describing the form of a hybrid digital twin model according to an embodiment.

FIGS. 5A and 5B are block diagrams for describing methods of arranging an field installation control system for process operation optimization according to an embodiment.

FIG. 6 is a flowchart illustrating an field installation control method for process operation optimization according to an embodiment.

### DETAILED DESCRIPTION

Unlike cloud computing in which all data generated in originating sites is transmitted to a centralized server and processed by the centralized server, edge computing in which at least part of data processing is performed in real time by small servers distributed and provided at the originating sites has been developed. The edge computing has an advantage in that, when a large amount of data is generated in an originating site, at least part of processing of the data is performed in a timely manner at the originating site such that the data is processed according to the speed of a target process being operated (i.e., in real time), and thus, data processing time is greatly reduced and bandwidth usage of a communication network for communication with a higher-level system is reduced.

Application of a combination of information and communications technology (ICT) techniques including digital twin or edge computing to industrial facilities, such as factories and plants, is emerging. Various studies have been conducted on intelligent industrial systems capable of improving productivity, quality, and efficiency by introducing ICT techniques, such as 5^{th} Generation (5G), artificial intelligence, or big data, into the overall operation of industrial facilities, away from the existing traditional industrial systems.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Advantages and features of the present disclosure and a method for achieving them will be apparent with reference to embodiments of the present disclosure described below together with the attached drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used in embodiments are selected as currently widely used general terms as possible, which may vary depending on intentions or precedents of one of ordinary skill in the art, emergence of new technologies, and the like. In addition, in certain cases, there are also terms arbitrarily selected by the applicant, and in this case, the meaning thereof will be defined in detail in the description. Therefore, the terms used herein should be defined based on the meanings of the terms and the details throughout the present description, rather than the simple names of the terms.

Terms used herein are for describing particular embodiments and are not intended to limit the scope of the present disclosure. A singular expression may include a plural expression unless they are definitely different in a context. As used herein, terms such as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

In addition, although terms such as “first” or “second” may be used herein to describe various elements, these elements should not be limited by these terms. These terms may be only used to distinguish one element from another.

Some embodiments of the present disclosure may be represented by functional block components and various processing operations. Some or all of the functional blocks may be implemented by any number of hardware and/or software elements that perform particular functions. For example, the functional blocks of the present disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. Furthermore, the present disclosure may employ known technologies for electronic settings, signal processing, and/or data processing. Terms such as “mechanism”, “element”, “unit”, or “component” are used in a broad sense and are not limited to mechanical or physical components.

Hereinafter, embodiments of the present disclosure will be described in detail with reference to the drawings.

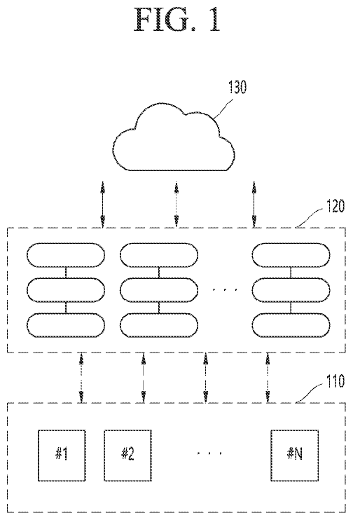

FIG. 1 is a diagram for describing an example of edge computing.

As illustrated in FIG. 1, an infrastructure for edge computing consists of three main layers. FIG. 1 illustrates an example of a device layer 110, an edge layer 120, and a cloud layer 130. The device layer 110 may include one or more devices, the edge layer 120 may include one or more edge nodes/servers, and the cloud layer 130 may be a cloud server, a data center, or the like.

The device layer 110 may perform data generation and consumption activities. The devices included in the device layer 110 may be of any type of device that generates data. The devices may be, for example, smart phones, tablet personal computers (PCs), PCs, smart televisions (TVs), personal digital assistants (PDAs), laptop computers, media players, or other mobile electronic devices. The devices may be, for example, vibration sensors, noise sensors, tension sensors, energy meters, installations, facilities, heavy equipment, controllers, or other equipment in factories, construction sites, industrial sites, and the like. While specific examples have been presented above, other examples of the devices may include a variety of devices in the art or any types of devices that are still evolving or not yet developed.

The cloud layer 130 is the highest layer and may be configured to handle a considerable amount of data, like a cloud server or a data center. The cloud layer 130 may provide a massive amount of storage and computing resources while providing a high-latency response to a device. In particular, an exponential increase in the amount of data generated and transmitted by devices that may be included in the device layer 110 due to technological development may cause an overload of a cloud server or a data center.

As illustrated in FIG. 1, in the edge computing, the edge layer 120 may be introduced between the device layer 110 and the cloud layer 130. The edge layer 120 analyzes and processes all data generated in the device layer 110 for data processing and storage, in particularly, a significantly amount of data, without the need to transmit the data to the cloud layer 130, and transmits or receives only necessary data to or from the cloud layer 130. Through the edge layer 120, data generated in the device layer 110 is analyzed in real time, and determination, processing, and decision-making for an immediate action are possible, without requiring the cloud layer 130 located remotely from the device layer 110 to perform such tasks.

The edge layer 120 may be located much closer to the device layer 130 than the cloud layer 130. Processors, memories, and storage resources provided at an edge of the edge layer 120 are critical to providing a significantly low-latency response for services and functions used by the device layer 130, and may improve energy consumption and overall network usage by reducing network backhaul traffic from the edge layer 120 toward the cloud layer 130.

Processors, memory, and storage are limited resources, and the amount thereof may generally decrease with edge location. In addition, space- and power-related limitations may increase as the device layer 110 is closer. Thus, the edge layer 120 may attempt to reduce the amount of resources required for network services by distributing more resources to a closer location in terms of both geography and network access time.

The infrastructure for edge computing illustrated in FIG. 1 is provided as an example, and those of skill in the art may understand that various infrastructures exist.

Hereinafter, it may be understood that an operation performed by a field installation control system, a subsystem included in the field installation control system, or a module included in the subsystem is performed by a processor of the field installation control system.

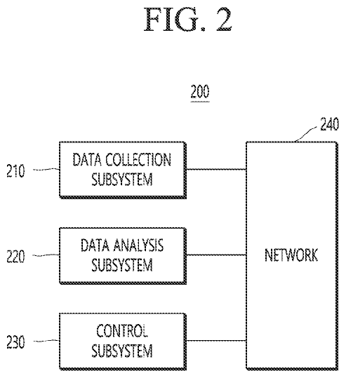

FIG. 2 is a block diagram of a field installation control system for process operation optimization according to an embodiment.

Referring to FIG. 2, a field installation control system 200 of the present disclosure may include a data collection subsystem 210, a data analysis subsystem 220, a control subsystem 230, and a network 240.

The data collection subsystem 210 may collect installation operation data from one or more field installations.

In the present disclosure, the field installation may include industrial facilities, installations, heavy equipment, controllers, or other various equipment in factories, plants, construction sites, industrial sites, and the like. As a specific example, the field installation may be an automobile welding robot for performing a welding function in an automobile factory. In addition, the field installation may be a semiconductor manufacturing installation, an installation for processing food such as ramen, or a paper manufacturing installation.

In the present disclosure, the field installation may generate various types of data. In the present disclosure, all data generated by such field installations may be referred to as ‘installation operation data’. The installation operation data may include temperature, humidity, current, voltage, speed, number of executions, moving distance, communication traffic, usage, occupancy rate, or other data related to various field installations. As a specific example, the installation operation data may include the welding speed of an automobile welding robot, the rotational speed of a robot arm, the temperature of the robot, the energy consumption of the robot, the identification number of the robot, the identification number of a vehicle, the identification number of a welding part, a time point of welding, a time period required for welding, and the like.

In an embodiment, the installation operation data may include field installation environment data and field installation management data. The field installation environment data may refer to data related to conditions in which a field installation performs a task, an environment in which the task is performed, and a state in which the task is performed. As a specific example, the field installation environment data may include a current and voltage supplied to an automobile welding robot, the welding speed of the robot, the rotational speed of a robot arm, the temperature of the robot, the energy consumption of the robot, and the temperature, humidity around the robot, and the like. Preferably, the field installation environment data may be collected every preset period. The field installation management data may refer to data related to specifying a field installation within a field such as a factory or a plant, or managing specifications or information of a field installation. As a specific example, the field installation management data may include the robot identification number of an automobile welding robot, an identification number of a vehicle, an identification number of a welding part, a time point of welding, a time period required for welding, and the like.

The data collection subsystem 210 may collect the installation operation data through sensors or cameras located at or close to the field installations, or other devices capable of sensing or detecting data generated by the field installations. In an embodiment, the data collection subsystem 210 may collect the installation operation data generated by the field installations every preset period. The preset period may be determined according to type and characteristics of field installation, specifications of system, or various other conditions. For example, the preset period may be 10 seconds, 30 seconds, 1 minute, 10 minutes, 30 minutes, or the like. The data collection subsystem 210 may transmit the collected data to the data analysis subsystem 220 through the network 240.

The data analysis subsystem 220 may receive the data collected by the data collection subsystem 210 through the network 240 and analyze the received data.

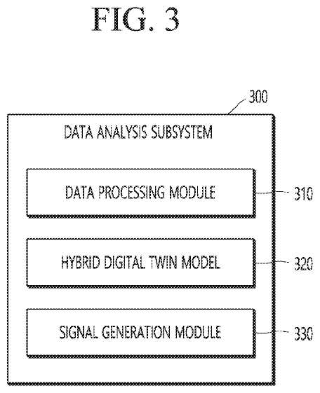

The data analysis subsystem 220 may analyze the state, operation, performance, abnormality, and the like of the field installations, based on data regarding the field installations and physical characteristics of the field installations, and generate a signal including information for improving the state, operation, performance, and the like of the field installations, or for enabling the field installations to operate normally. In detail, the data analysis subsystem 220 may process the data collected by the data collection subsystem 210 for input to a processing model, input the processed data to the processing model, analyze processing result data by the model to generate a control information signal, and output the control information signal. The data analysis subsystem 220 will be described in more detail below with reference to FIG. 3. The data analysis subsystem 220 transmits the generated control information signal to the control subsystem 230 through the network 240.

The control subsystem 230 may receive the control information signal output by the data analysis subsystem 220 through the network 240, and control one or more field installations based on the control information signal.

The control information signal received by the control subsystem 230 may include information necessary to improve the state, operation, performance, and the like of the field installations, or to control the field installations to be normally operated. For example, the control information signal may include information that a value of a tunable component needs to be increased such that a current supplied to an automobile welding robot falls within a normal range. For example, the control information signal may include information that the intensity of a cooler needs to be increased such that the temperature of the automobile welding robot falls within a normal range. For example, the control information signal may include information that the temperature of oil in a fryer needs to be decreased and a drying time needs to be increased to minimize browning of ramen noodles according to the flour content. For example, the control information signal may include information that a composition ratio of a particular etching gas needs to be increased to increase semiconductor yield. In addition to the above examples, the control information signal may include any suitable information for enabling a field installation to operate in a suitable environment and achieve its best performance.

The network 240 may communicatively connect to each subsystem. In addition, the network 240 may allow the field installation control system 200 to communicate with external devices and systems. For example, installation operation data, sensor information, user inputs, artificial intelligence learning and inference models, physical models, control information signals, control signals, and the like may be transmitted and received through the network 240.

The network 240 may enable data transmission and reception by using any suitable wired or wireless communication technique. For example, the wired communication technique used by the network 240 may include Ethernet, Universal Serial Bus (USB), power line communication, telephone line communication, local area network (LAN), and the like. For example, the wireless communication techniques used by the network 240 may include Global System for Mobile communication (GSM), code-division multiple access (CDMA), Long-Term Evolution (LTE), 5^{th} Generation (5G), wireless LAN (WLAN), Wireless-Fidelity (Wi-Fi), Bluetooth, radio-frequency identification (RFID), Infrared Data Association (IrDA), ZigBee, near-field Communication (NFC), and the like.

In an embodiment, the field installation control system 200 of the present disclosure may further include a data generation subsystem (not shown).

In an embodiment, the data generation subsystem (not shown) may generate virtual installation operation data regarding one or more field installations. In the present disclosure, while the installation operation data is real installation operation data collected by the data collection subsystem 210, the virtual installation operation data is not data actually generated by a field installation, and may refer to data generated by the data generation subsystem (not shown) inferring from real installation operation data.

Thus, the virtual installation operation data may include data of various types and characteristics generated by field installations, like the installation operation data. For example, the virtual installation operation data may include temperature, humidity, current, voltage, speed, number of executions, moving distance, communication traffic, usage, occupancy rate, or other generated data related to various field installations. As a specific example, the virtual installation operation data may be data generated to correspond to the welding speed of an automobile welding robot, the rotational speed of a robot arm, the temperature of the robot, the energy consumption of the robot, the identification number of the robot, the identification number of a vehicle, the identification number of a welding part, a time point of welding, and a time period required for welding.

It will be easily understood by those of skill in the art that the above examples of installation operation data may be equally or similarly applied to virtual installation operation data, and thus, examples of virtual installation operation data will be omitted.

In an embodiment, the data generation subsystem (not shown) may include a generative adversarial network (GAN).

In the present disclosure, the GAN includes a model commonly used in machine learning, a model commonly used in deep learning, and the like. The GAN may include a generator model and a discriminator model, the generator model included in the GAN may be trained to generate data equivalent to real data, and the discriminator model included in the GAN may be trained to classify the data generated by the generator model. That is, the generator model and the discriminator model included in the GAN are adversarially trained, and as a result, the GAN may generate data close to real data.

In the above-described embodiment, the data generation subsystem (not shown) may include a GAN and thus be able to generate virtual installation operation data that is significantly close to real installation operation data collected by the data collection subsystem 210.

In an embodiment, the data generation subsystem (not shown) may transmit the generated virtual installation operation data to the data analysis subsystem 220 through the network 240. The virtual installation operation data transmitted to the data analysis subsystem 220 may be processed into training data for training a hybrid digital twin model of the present disclosure.

Accordingly, in an embodiment, the hybrid digital twin model may be trained based on not only the installation operation data collected by the data collection subsystem 210, but also the virtual installation operation data generated by the data generation subsystem (not shown).

Compared to the installation operation data collected by the data collection subsystem 210, the virtual installation operation data generated by the data generation subsystem (not shown) may include a large amount of data. Thus, the hybrid digital twin model may be trained based on a large amount of data, and thus may exhibit better performance than when trained based on only the installation operation data collected by the data collection subsystem 210.

In addition, compared to the installation operation data collected by the data collection subsystem 210, the virtual installation operation data generated by the data generation subsystem (not shown) may include extreme data that is exceptional, anomalous, or overflowing. Therefore, the hybrid digital twin model may be trained based various pieces of data, and thus may provide field installation control for preparing for unpredictable situations.

Those of skill in the art will understand that the field installation control system 200 for process operation optimization of the present disclosure may include, although not illustrated, components such as a processor, a communication unit, or a memory, which are necessary to operate the entire system, and may include field installation control of the present disclosure, and each of the subsystems included in the field installation control system 200 of the present disclosure may include, although not illustrated, components such as a subprocessor, a communication unit, or a memory, which are necessary to perform an operation.

The communication unit may include one or more components for performing wired/wireless communication with an external server or an external device. For example, the communication unit may include at least one of a short-range communication unit, a mobile communication unit, and a broadcast receiving unit.

The memory is hardware for storing various pieces of data processed by the field installation control system for process operation optimization, and may store programs for the processor to perform processing and control.

The memory may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor controls the overall operation of the field installation control system for process operation optimization. For example, the processor may execute programs stored in the memory to control the overall operation of an input unit, a display, the communication unit, the memory, and the like. The processor may execute programs stored in the memory to control the operation of the field installation control system for process operation optimization.

The processor may control at least some of operations performed by the field installation control system for process operation optimization, which are described in the present disclosure.

The processor may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

FIG. 3 is a block diagram illustrating a data analysis subsystem according to an embodiment.

Referring to FIG. 3, a data analysis subsystem 300 according to an embodiment may include a data processing module 310, a hybrid digital twin model 320, and a signal generation module 330. The data analysis subsystem 300 of FIG. 3 may be the same as the data analysis subsystem 220 of FIG. 2.

The data processing module 310 may process data (i.e., installation operation data) collected and transmitted by the data collection subsystem through a network, into a form suitable to be input to the hybrid digital twin model 320. For example, data processing performed by the data processing module 310 may include data preprocessing in the field of machine learning. For example, the data processing performed by the data processing module 310 may include removing unnecessary data, assigning a particular value to missing data, and the like. For example, the data processing performed by the data processing module 310 may include data encoding or transformation, such as conversion of text data into numbers, data categorization, logarithmic transformation, or reciprocal transformation. For example, the data processing performed by the data processing module 310 may include value scaling such as normalization or standardization. For example, the data processing performed by the data processing module 310 may include outlier processing. For example, the data processing performed by the data processing module 310 may include data sampling. For example, the data processing performed by the data processing module 310 may include processing data into training data or processing data into validation data. In addition, the data processing performed by the data processing module 310 may include any suitable process depending on the type of a field installation, the format and type of data generated by the field installation, the design of the hybrid digital twin model 320, the purpose of field installation control, and the like.

In addition, the data processing module 310 may process data (i.e., virtual installation operation data) generated and transmitted by the data generation subsystem through the network, into a form suitable to be input to the hybrid digital twin model 320. It will be easily understood by those of skill in the art that the operation performed by the data processing module 310 related to the above-described data processing may also be applied to virtual installation operation data, and thus, descriptions thereof will be omitted.

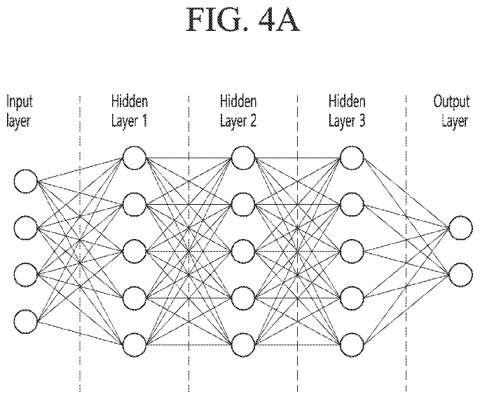

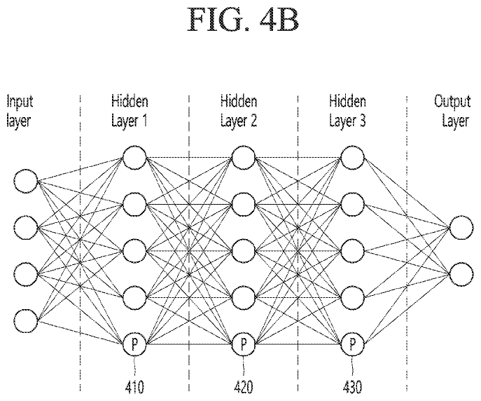

The hybrid digital twin model 320 may receive the processed data from the data processing module 310 and process the received data. The hybrid digital twin model 320 of the present disclosure may be designed by a combination of an artificial intelligence learning and inference model and a physical model regarding a field installation. The hybrid digital twin model 320 of the present disclosure may be trained and designed based on installation operation data regarding a field installation. In addition, the hybrid digital twin model 320 of the present disclosure may be trained and designed based on virtual installation operation data regarding a field installation. In addition, the hybrid digital twin model 320 of the present disclosure may include both a model trained and designed based on installation operation data regarding a field installation, and a model trained and designed based on virtual installation operation data regarding a field installation. In addition, the hybrid digital twin model 320 of the present disclosure may be trained and designed based on both installation operation data regarding a field installation and virtual installation operation data regarding a field installation. The hybrid digital twin model 320 processes input data and transmits the processed data to the signal generation module 330. The hybrid digital twin model 320 will be described in more detail below with reference to FIGS. 4A and 4B. The hybrid digital twin model 320 transmits a data processing result to the signal generation module 330.

The signal generation module 330 may receive and analyze a result of data processing by the hybrid digital twin model 320, and output a control information signal. As described above with reference to FIG. 2, the control information signal generated by the signal generation module 330 may include information necessary to improve the state, operation, performance, and the like of a field installation or to control the field installation to be operated normally. The control information signal generated by the signal generation module 330 may have any form, structure, or characteristics suitable for controlling the field installation.

Those of skill in the art will understand that each module and model included in the data analysis subsystem 300 of the present disclosure may include, although not illustrated, components such as a communication unit or a memory, when necessary.

As described above, the hybrid digital twin model 320 of the present disclosure may be designed by fusing an artificial intelligence learning and inference model with a physical model regarding a field installation.

In the present disclosure, the artificial intelligence learning and inference model may be a model having any structure, form, or characteristics suitable for processing data according to a field installation or according to data generated by the field installation. In the present disclosure, the artificial intelligence learning and inference model includes models commonly used in machine learning, models commonly used in deep learning, and the like. In an embodiment, the artificial intelligence learning and inference model may be an existing operational learning model or a newly designed learning model based on existing data.

In an embodiment, the artificial intelligence learning and inference model of the present disclosure may include an artificial neural network.

The artificial neural network may refer to all models having a problem solving ability and consisting of artificial nodes (neurons) that constitute a network by connection of synapses. The artificial neural network may be defined by a connection pattern between nodes in different layers, a training process that updates model parameters, and an activation function that generates an output.

The artificial neural network may include a plurality of layers. Each layer may include one or more nodes, and the artificial neural network may include nodes and synapses connecting the nodes to each other. In an artificial neural network, each node may output a function value of an activation function for input signals, weights, and biases input through the synapses.

The model parameters refer to parameters determined through training, and may include weights of synaptic connections and biases of the nodes. In addition, hyperparameters refer to parameters that need to be set in a machine learning algorithm before training, and may include a learning rate, the number of iterations, a mini-batch size, an initialization function, and the like.

The purpose of training the artificial neural network may be determining the model parameters that minimize the loss function. The loss function may be used as an indicator for determining optimal model parameters in the process of training the artificial neural network. The artificial neural network may be trained through forward propagation and backpropagation.

In the present disclosure, the physical model is a preliminary numerical analysis and simulation model based on physical characteristics, and is a model that describes a physical phenomenon by deductive reasoning according to physical laws. In the present disclosure, the physical model regarding the field installation may refer to a simulation and numerical analysis model that is linked to field installation operation including the field installation itself, materials constituting the field installation, and a material to be processed, an operation performed by the field installation, a process performed by the field installation, and the like, and describes physical phenomena that occur in relation to the field installation. In an embodiment, the physical model that is fused into the hybrid digital twin model may be received through a network.

In an embodiment, the hybrid digital twin model may include one or more artificial intelligence learning and inference models. The hybrid digital twin model may include any suitable number of artificial intelligence learning and inference models to implement the field installation control system for process operation optimization. In an embodiment, the hybrid digital twin model may include the same number of artificial intelligence learning and inference models, as the number of types of installation operation data, the number of types of field installations, the number of field installations, or the like.

In the present disclosure, by introducing the hybrid digital twin model in which the artificial intelligence learning and inference model and the physical model are fused, it is possible to flexibly perform backpropagation in the analysis model that is the backbone that plays a role in analyzing data in the field installation control system, and thus, it is also possible to derive not only output prediction according to an input change, but also an input change required to obtain a target output.

FIGS. 4A and 4B are schematic diagrams for describing the form of a hybrid digital twin model according to an embodiment.

FIG. 4A illustrates an example of an artificial neural network of an artificial intelligence learning and inference model that may be fused into a hybrid digital twin model. The artificial neural network of FIG. 4A may include a plurality of layers. In an embodiment, as illustrated in FIG. 4A, the artificial neural network may include an input layer, an output layer, and three hidden layers (hidden layer 1, hidden layer 2, and hidden layer 3). In an embodiment, each layer included in the artificial neural network includes a plurality of nodes. In an embodiment, each node of a layer included in the artificial neural network may be connected to all nodes of an adjacent layer.

FIG. 4B is a diagram for describing an embodiment of a hybrid digital twin model in which an artificial intelligence learning and inference model and a physical model regarding a field installation are fused. Referring to FIG. 4B, in an embodiment, a physical node 410, a physical node 420, and a physical node 430 are included in three hidden layers, respectively. In an embodiment, the physical nodes 410, 420, and 430 included in the artificial neural network may be nodes that implement physical models regarding a field installation. In an embodiment, weights of the physical nodes 410, 420, and 430 may be updated in a different way from those of other nodes. For example, the physical nodes 410, 420, and 430 may not be affected by backpropagation. For example, the physical nodes 410, 420, and 430 may be updated at a period different from that of other nodes. For example, the physical nodes 410, 420, and 430 may be designed to be updated only through a direct user input. For example, the physical nodes 410, 420, and 430 may be designed to be updated only through a download from a server external to the field installation control system. In the same manner as illustrated in FIG. 4B, the artificial intelligence learning and inference model and the physical model regarding the field installation may be fused.

FIGS. 4A and 4B are intended to illustrate an embodiment in which an artificial intelligence learning and inference model and a physical model regarding a field installation are fused. That is, although FIGS. 4A and 4B illustrate that three hidden layers are included, this is only an example, and the artificial neural network may include any number of hidden layers suitable for implementation of the present disclosure. Similarly, the number of nodes included in each layer in FIG. 4A is only an example, and each layer included in the artificial neural network may include any number of nodes suitable for implementation of the present disclosure. Similarly, although FIG. 4B illustrates that all hidden layers include physical nodes, this is only an example, and only some of the plurality of hidden layers may include physical nodes. In addition, the hybrid digital twin model may be implemented in any suitable structure and form different from those illustrated in FIGS. 4A and 4B.

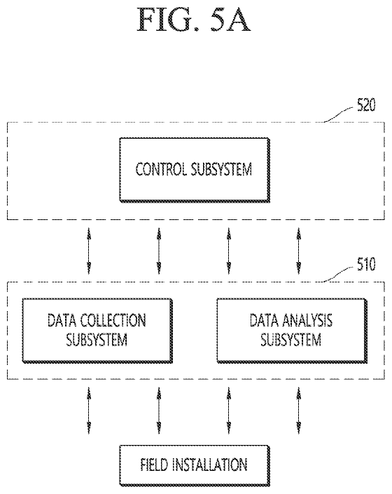

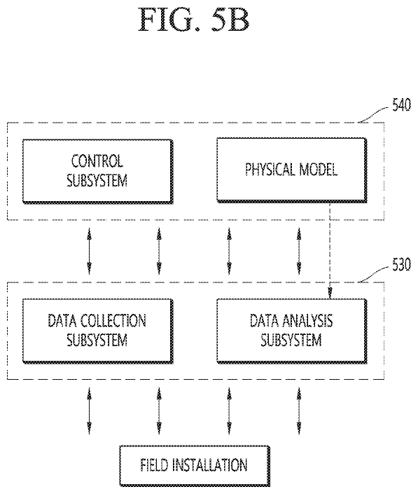

FIGS. 5A and 5B are block diagrams for describing methods of arranging an field installation control system for process operation optimization according to an embodiment.

Referring to FIG. 5A, in an embodiment, a data collection subsystem and a data analysis subsystem are provided in an edge computing node 510, and a control subsystem is provided in a back-end computing node 520.

The edge computing node 510 of FIG. 5A may refer to the edge layer 120 of FIG. 1 or may be included in the edge layer 120, and the back-end computing node 520 of FIG. 5A may refer to the cloud layer 130 of FIG. 1 or may be included in the cloud layer 130.

The data collection subsystem, the data analysis subsystem, and the control subsystem of FIG. 5A may be implemented according to the respective embodiments described above in the present disclosure. That is, the data collection subsystem of FIG. 5A may include the data collection subsystem 210 of FIG. 2, the data analysis subsystem of FIG. 5A may include the data analysis subsystem 220 of FIG. 2 or the data analysis subsystem 300 of FIG. 3, and the control subsystem of FIG. 5A may include the control subsystem 230 of FIG. 2. In FIG. 5A, data and signal transmission and reception between a field installation and the edge computing node 510 or the back-end computing node 520, or data and signal transmission and reception between the subsystems may be performed through a network, although not illustrated, and the network may include the network 240 of FIG. 2.

As illustrated in FIG. 5A, in an embodiment, the data collection subsystem and the data analysis subsystem are provided in the edge computing node 510 that is close to the field installation, and thus, operations such as collection of installation operation data or analysis of collected data, which are required to be performed in real time, may be performed at a location close to the field installation. In an embodiment, the control subsystem that performs operations having relatively non-real-time characteristics is provided in the back-end computing node 520, and thus, resources of the entire system may be effectively distributed and overload may be prevented.

Referring to FIG. 5B, in an embodiment, a data collection subsystem and a data analysis subsystem are provided in an edge computing node 530, and a control subsystem and a physical model are provided in a back-end computing node 540.

The edge computing node 530 of FIG. 5B may refer to the edge layer 120 of FIG. 1, and the back-end computing node 540 of FIG. 5B may refer to the cloud layer 130 of FIG. 1.

The data collection subsystem, the data analysis subsystem, and the control subsystem of FIG. 5B may be implemented according to the respective embodiments described above in the present disclosure. That is, the data collection subsystem of FIG. 5B may include the data collection subsystem 210 of FIG. 2, the data analysis subsystem of FIG. 5B may include the data analysis subsystem 220 of FIG. 2 or the data analysis subsystem 300 of FIG. 3, and the control subsystem of FIG. 5B may include the control subsystem 230 of FIG. 2. In addition, the physical model of FIG. 5B may include a physical model that is fused into the hybrid digital twin model described above. In FIG. 5B, data and signal transmission and reception between a field installation and the edge computing node 530 or the back-end computing node 540, or data and signal transmission and reception between the subsystems may be performed through a network, although not illustrated, and the network may include the network 240 of FIG. 2.

As illustrated in FIG. 5B, in an embodiment, the data collection subsystem and the data analysis subsystem are provided in the edge computing node 530 that is close to the field installation, and thus, operations such as collection of installation operation data or analysis of collected data, which are required to be performed in real time, may be performed at a location close to the field installation. In an embodiment, the control subsystem that performs operations having relatively non-real-time characteristics and the physical model that does not need to be changed in real time are provided in the back-end computing node 540, and thus, resources of the entire system may be effectively distributed and overload may be prevented.

As described above, the hybrid digital twin model of the present disclosure may be designed by fusing an artificial intelligence learning and inference model with a physical model regarding a field installation. However, the hybrid digital twin model may be included in the data analysis subsystem provided in the edge computing node 530. Thus, in an embodiment, the physical model to be fused into the hybrid digital twin model may be loaded from the back-end computing node 540 through the network and then used. In an embodiment, the physical model to be fused into the hybrid digital twin model may be loaded from the back-end computing node 540 and updated every preset period. The preset period may preferably be greater than a training period of the hybrid digital twin model. In an embodiment, the physical model to be fused into the hybrid digital twin model may be loaded from the back-end computing node 540, based on determining whether the physical model is identical to the physical model provided in the back-end computing node 540 (i.e., determining whether the physical model is the latest physical model), and then updated. In an embodiment, the physical model to be fused into the hybrid digital twin model may be newly loaded from the back-end computing node 540 and updated only when the physical model provided in the back-end computing node 540 has been changed (i.e., updated).

In addition to the above-described embodiments, any suitable arrangement method capable of effectively distributing resources and preventing overload of the field installation control system of the present disclosure may be adopted.

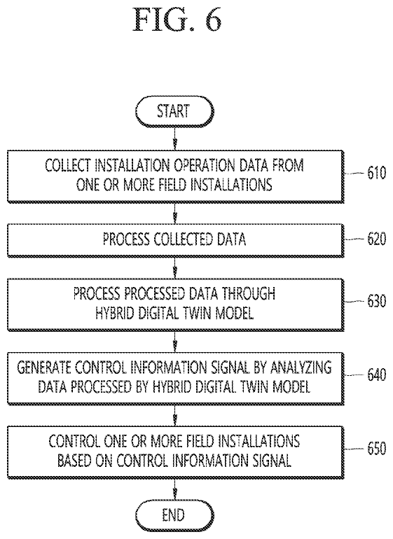

FIG. 6 is a flowchart illustrating an field installation control method for process operation optimization according to an embodiment.

The field installation control method for process operation optimization illustrated in FIG. 6 is related to the above-described embodiments, and thus, the descriptions of the embodiments provided above, even omitted below, may also be applied to the method of FIG. 6.

The operations illustrated in FIG. 6 may be performed by the above-described field installation control system for process operation optimization. In detail, the operations illustrated in FIG. 6 may be performed by a processor that controls the overall operation of the above-described field installation control system for process operation optimization.

In operation 610, installation operation data may be collected from one or more field installations.

In an embodiment, the installation operation data may include field installation environment data and field installation management data.

In an embodiment, operation 610 may be performed every preset period.

In an embodiment, operation 610 may be performed at an edge computing node.

In operation 620, the collected data may be processed.

In an embodiment, operation 620 may be performed at the edge computing node.

In operation 630, the processed data may be processed through a hybrid digital twin model.

In an embodiment, the hybrid digital twin model may be designed by fusing an artificial intelligence learning and inference model with a physical model regarding a field installation, and may be trained based on installation operation data regarding one or more field installations.

In an embodiment, the artificial intelligence learning and inference model may include an input layer, an output layer, and one or more hidden layers between the input layer and the output layer.

In an embodiment, at least some of the one or more hidden layers may include nodes implementing a physical model.

In an embodiment, operation 630 may be performed at the edge computing node.

In an embodiment, the physical model to be fused into the hybrid digital twin model may be obtained by loading a physical model provided in a back-end computing node through a network.

In operation 640, a control signal may be generated by analyzing the data processed by the hybrid digital twin model.

In an embodiment, operation 640 may be performed at the edge computing node.

In operation 650, the one or more field installations may be controlled based on the control signal.

In an embodiment, operation 650 may be performed at a back-end computing node.

In an embodiment, the back-end computing node may exist in a cloud server.

In an embodiment, the method may further include training the hybrid digital twin model based on installation operation data regarding one or more field installations.

In an embodiment, the method may further include generating virtual installation operation data regarding one or more field installations.

In an embodiment, the generating of the virtual installation operation data may be performed based on a GAN.

In an embodiment, the hybrid digital twin model may further include a model trained based on virtual installation operation data regarding one or more field installations.

Embodiments of the present disclosure may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

Meanwhile, the computer program may be specially designed and configured for the present disclosure or may be well-known to and usable by those skill in the art of computer software. Examples of the computer program may include not only machine code, such as code made by a compiler, but also high-level language code that is executable by a computer by using an interpreter or the like.

According to an embodiment, the method according to various embodiments of the present disclosure may be included in a computer program product and provided. The computer program products may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

The operations of the methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. In addition, various modifications, combinations, and adaptations will be readily apparent to those skill in the art without departing from the following claims and equivalents thereof.

Accordingly, the spirit of the present disclosure should not be limited to the above-described embodiments, and all modifications and variations which may be derived from the meanings, scopes and equivalents of the claims should be construed as failing within the scope of the present disclosure.

By introducing a hybrid digital twin model designed by fusing a preliminary numerical analysis and simulation model based on physical characteristics, with an artificial intelligence learning and inference model based on installation operation data, it is possible to provide field installation control that quickly derives a result and exhibits high-accuracy performance. In addition, the hybrid digital twin model is a measurable surrogate model with a clear confidence interval, may provide real-time decisions and accurate control, and may be easily updated according to an on-site process, the state or aging of an installation, or the like.

In addition, a field installation control system based on a hybrid digital twin model that effectively controls field installations in real time, such as appropriate resource distribution or low-latency response, may be implemented by applying edge computing technology to the field installation control system. It is possible to improve productivity on a field, enhance safety of workers, reduce costs, and enhance industrial competitiveness, through real-time control of field installations.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An artificial intelligence based field installation control system for process operation optimization, the field installation control system comprising:
a data collection subsystem configured to collect installation operation data, from one or more field installations;
a data analysis subsystem configured to analyze the data collected by the data collection subsystem; and
a control subsystem configured to control the one or more field installations, based on an output of the data analysis subsystem,
wherein the data collection subsystem, the data analysis subsystem, and the control subsystem are communicatively connected to each other through a network,
wherein the data analysis subsystem comprises:
a data processing module configured to process the data collected by the data collection subsystem;
a hybrid digital twin model configured to process the data processed by the data processing module; and
a signal generation module configured to analyze the data processed by the hybrid digital twin model and output a control information signal, and
wherein the hybrid digital twin model is a fusion of an artificial intelligence learning and inference model, which is based on installation operation data, with a physical model regarding the one or more field installations, and is trained based on installation operation data regarding the one or more field installations.

2. The field installation control system of claim 1, wherein the installation operation data comprises field installation environment data and field installation management data.

3. The field installation control system of claim 1, further comprising a model training subsystem configured to train the hybrid digital twin model, based on the installation operation data regarding the one or more field installations.

4. The field installation control system of claim 1, wherein the artificial intelligence learning and inference model comprises:
an input layer;
an output layer; and
one or more hidden layers between the input layer and the output layer, and
wherein at least some of the one or more hidden layers comprise nodes implementing the physical model.

5. The field installation control system of claim 1, wherein the data collection subsystem and the data analysis subsystem are arranged in an edge computing node, and
wherein the control subsystem is arranged in a back-end computing node.

6. The field installation control system of claim 5, wherein the physical model regarding the one or more field installations is arranged in the back-end computing node, and
wherein the physical model fused into the hybrid digital twin model is configured to be obtained by loading the physical model arranged in the back-end computing node through the network.

7. The field installation control system of claim 5, wherein the back-end computing node is in a cloud server.

8. The field installation control system of claim 1, wherein the hybrid digital twin model comprises the same number of artificial intelligence learning and inference models as the number of types of the installation operation data.

9. The field installation control system of claim 1, further comprising a data generation subsystem configured to generate virtual installation operation data regarding the one or more field installations,
wherein the hybrid digital twin model further comprises a model trained based on the virtual installation operation data regarding the one or more field installations.

10. The field installation control system of claim 9, wherein the data generating subsystem comprises a generative adversarial network (GAN).

11. An artificial intelligence based field installation control method for process operation optimization, the field installation control method comprising:
collecting installation operation data from one or more field installations;
analyzing the collected data; and
controlling the one or more field installations, based on a result of the analyzing, wherein the analyzing comprises:
processing the collected data;
processing the processed data, through a hybrid digital twin model; and
generating a control information signal by analyzing the data processed by the hybrid digital twin model, and
wherein the hybrid digital twin model is a fusion of an artificial intelligence learning and inference model, which is based on installation operation data, with a physical model regarding the one or more field installations, and is trained based on installation operation data regarding the one or more field installations.

12. A non-transitory computer-readable recording medium for storing instructions, when executed by one or more processors, configured to perform the method of claim 11.
